(19) United States
(12) Patent Application Publication
(10) Pub. No.: US 2011/0191381 A1
(43) Pub. Date: Aug. 4, 2011

(54) Interactive System for Extracting Data from a Website

(75) Inventors: Shuyi Zheng, State College, PA (US); Ruihua Song, Beijing (CN); Matthew Robert Scott, Beijing (CN); Ji-Rong Wen, Beijing (CN)

(73) Assignee: Microsoft Corporation, Redmond, WA (US)

(21) Appl. No.: 12/696,061

(22) Filed: Jan. 29, 2010

(51) Int. Cl. G06F 17/30

(52) U.S. Cl. 707/793; 707/E17.022

(57) ABSTRACT

Described is a technology for efficiently labeling a webpage. A wrapper tool labels records of a webpage at the record level. If an existing wrapper exists that is appropriate for labeling a record, the wrapper tool automatically labels that record. For unlabeled records, the tool provides a user interface to label those records, and updates the set of existing wrappers with a new wrapper that is generated based upon the labeling operation; the new wrapper is then applied to any unlabeled records if appropriate for those records. As a result, a user typically needs only to label a relatively few records, with the wrappers generated for those records automatically used to label the other unlabeled records of the webpage.

### BACKGROUND

The Internet contains vast amounts of information from which users can find relevant content. However, the relevant content is generally embedded in HTML pages which are designed to be rendered for viewing. As a result, extracting the content of a webpage for other purposes (e.g., to create an RSS feed, to insert appropriately-formatted data into a spreadsheet, and so forth) is somewhat difficult.

A wrapper may be defined as a software program that extracts desired information from a source page and transforms it into a structured format. Because of the numerous ways in which source data may be structured and reformatted as desired, and because pages and formats change over time, various types of wrappers exist. Manually coding such wrappers is difficult, and thus automatic methods, referred to as wrapper induction, are often used to develop wrappers for webpages.

Automatic wrapper induction methods can be generally divided into two types of approaches based on how they are generated. One type of approach generates wrappers without pre-labeled training samples. In practice, however, these methods are difficult to apply to commercial systems that demand high extraction accuracy and performance.

Another group uses manually labeled examples as training data. For manually labeled training, a user defines an extraction schema and labels a set of training pages with the schema. Then, the labeled training pages are fed into a wrapper-induction system that generates one or more wrappers. When a new page is acquired, a wrapper is selected to extract data and fit the extracted data into the pre-defined schema.

While such training based wrapper generation methods can achieve desirable extraction performance, they can be problematic, as labeling is costly and error-prone. There is thus a tradeoff between high extraction accuracy and labeling costs.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a wrapper tool uses existing wrappers to automatically assign labels to records of a webpage when an existing wrapper corresponds to that record. For unlabeled records, the tool provides a user interface to label those records, and updates the set of existing wrappers with a new wrapper that is generated based upon the labeling operation.

The technology tool thus generates wrappers for individual records of a webpage, that is, at the record-level, rather than a wrapper for the entire webpage. Further, the technology employs a labeling strategy, referred to as wrapper-assisted labeling, that utilizes previously generated wrappers to label additional records of a partially labeled page, or some or all of the records of a wholly new page, when applicable.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example record-level wrapper tool that facilitates labeling and extraction of records of a webpage.

FIG. 2 is a flow diagram representing example steps that may be taken by a record-level wrapper tool.

FIG. 3 is a representation of a screenshot showing how the record-level wrapper tool allows interaction to label a record of a webpage.

FIG. 4 is a representation of a screenshot showing how the record-level wrapper tool allows further interaction to label any unlabeled (or similarly mislabeled) records of a webpage.

FIG. 5 shows an illustrative example of a computing environment into which various aspects of the present invention may be incorporated.

### DETAILED DESCRIPTION

Various aspects of the technology described herein are generally directed towards a labeling tool that generates wrappers for records of a webpage, that is, at the record-level (in contrast to conventional wrapper induction methods that operate at the page-level). Further, the technology employs a labeling strategy, referred to as wrapper-assisted labeling, that utilizes previously generated wrappers to label additional records of a partially labeled page, or some or all of the records of a wholly new page.

It should be understood that any of the examples herein are non-limiting. Indeed, a particular implementation having a labeling tool with a certain user interface is described, however this is only one example. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and webpage processing technology in general.

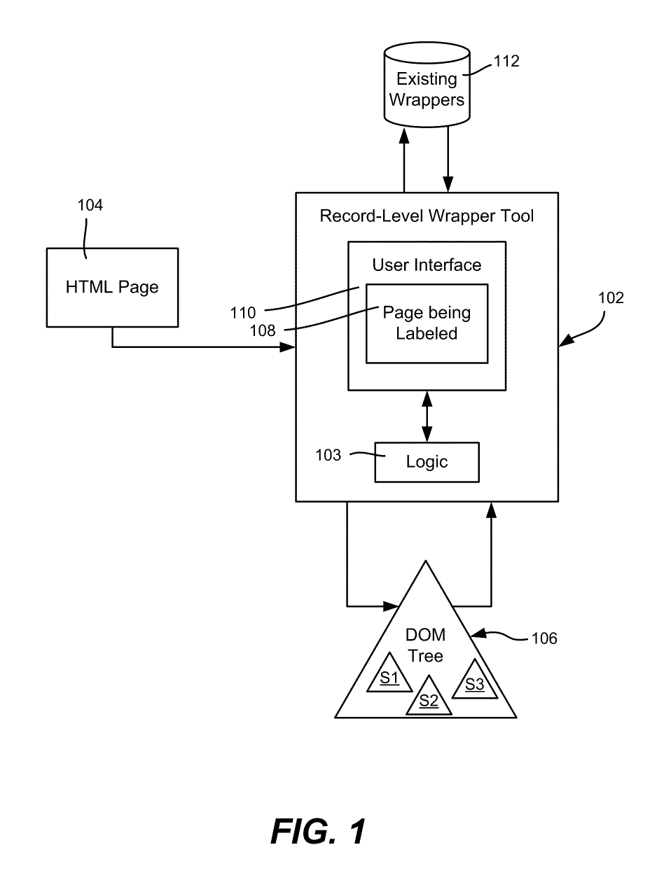

Turning to FIG. 1, there is shown an interactive wrapper labeling and training system in the form of a record-level wrapper tool 102, which may be used to visually label webpages (e.g., the page 104) and also generate wrappers as labeling occurs. As will be understood, this helps to reduce labeling costs while being able to extract data with high accuracy. More particularly, the tool 102 includes logic 103 (e.g., program code) that automatically labels records when possible, and thereby reduces the labeling cost of each page, because not all records need to be labeled manually, and because when a new unlabeled page is available for labeling, it is likely that at least some of the labeling can be done automatically.

As described herein, instead of labeling via wrappers at the page level, record-level wrappers are used, which avoid repetitive labeling on the same page of records having identical or very similar structures. To this end, a Document Object Model (“DOM”) tree 106 is used to model a webpage in a known manner. However, as described herein, the wrappers are trained at a record level instead of generating page-level wrappers. More specifically, when a user finishes labeling one record of a page that is being labeled 108 (via a user interface 110 as described below), the tool 102 and its logic 103 extracts a sub-DOM tree (e.g., S1, S2 or S3 in FIG. 1) corresponding to the record, and provides the sub-DOM tree to an incremental wrapper updating process.

Thus, when a generated wrapper is used to extract data, the wrapper does so at the record level, instead of the whole page. In other words, a wrapper is able to match a sub-DOM tree corresponding to a record of a page, then extract data from the matched sub-tree. When multiple wrappers match the same sub-tree, the tool 102 automatically selects a wrapper with the best/closest match (minimal distance to matched sub-tree) to perform the extraction.

Turning to another aspect, wrapper-assisted labeling uses previously generated wrappers to predict labels of similar records. This is accomplished by performing data extraction using existing wrappers 112, including any of those previously generated while labeling the current page. Wrapper-assisted labeling is advantageous because it can avoid repeatedly labeling records with the same or similar internal structure, and thus reduces the overall labeling effort.

The amount of labeling effort that record-level wrapper-assisted labeling can save can be formalized by considering the labeling of a group of pages from the same template, in which the total number of records is Nᵣ. According to the records' internal structures, all Nᵣ records can be virtually partitioned into Nₛ subsets. Records in each subset have the same internal structure. Then, with a wrapper-assisted labeling strategy, the user only needs to label one representative record for each subset, and use the wrapper that is generated from that labeling operation to automatically assign labels for the rest of the records. As a result, the maximal number of records that need to be labeled is Nₛ. In general, Nₛ<Nᵣ; for example, statistical analysis of seven well-known online shopping websites shows that that the ratio of Nₛ to Nᵣ is approximately 1.00 to 9.58.

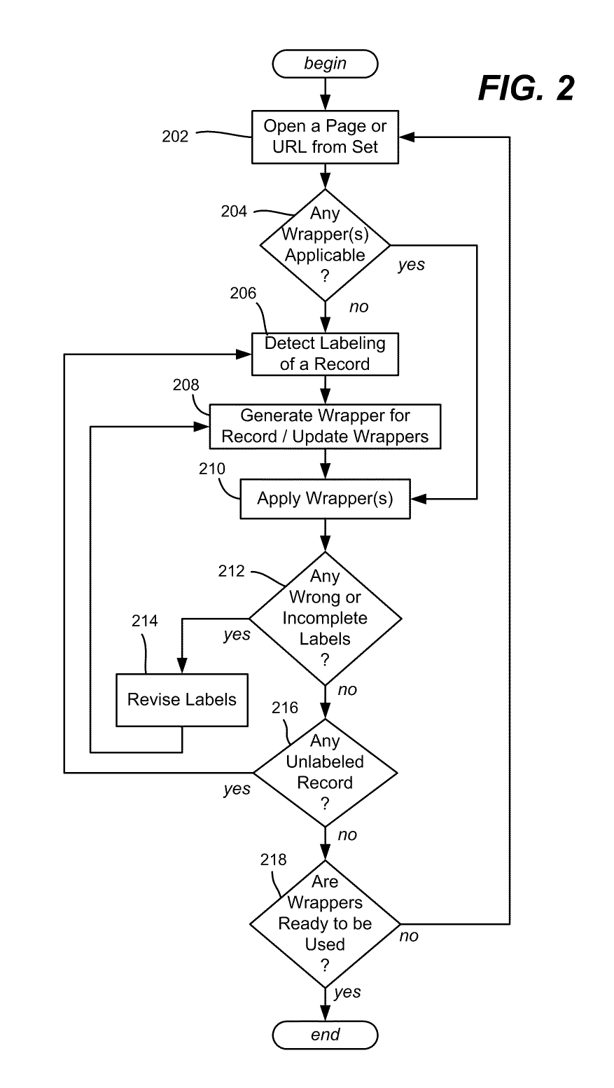

FIG. 2 is a flow diagram representing example steps taken by the labeling tool 102, including its logic 103 and the user interface 110. Given a set of pages (or URLs), a typical workflow of page labeling and wrapper generation begins at step 202 which represents opening a page or URL identified in the set, that is, one that has not already been labeled. Note that during the labeling process, each individual page is labeled separately.

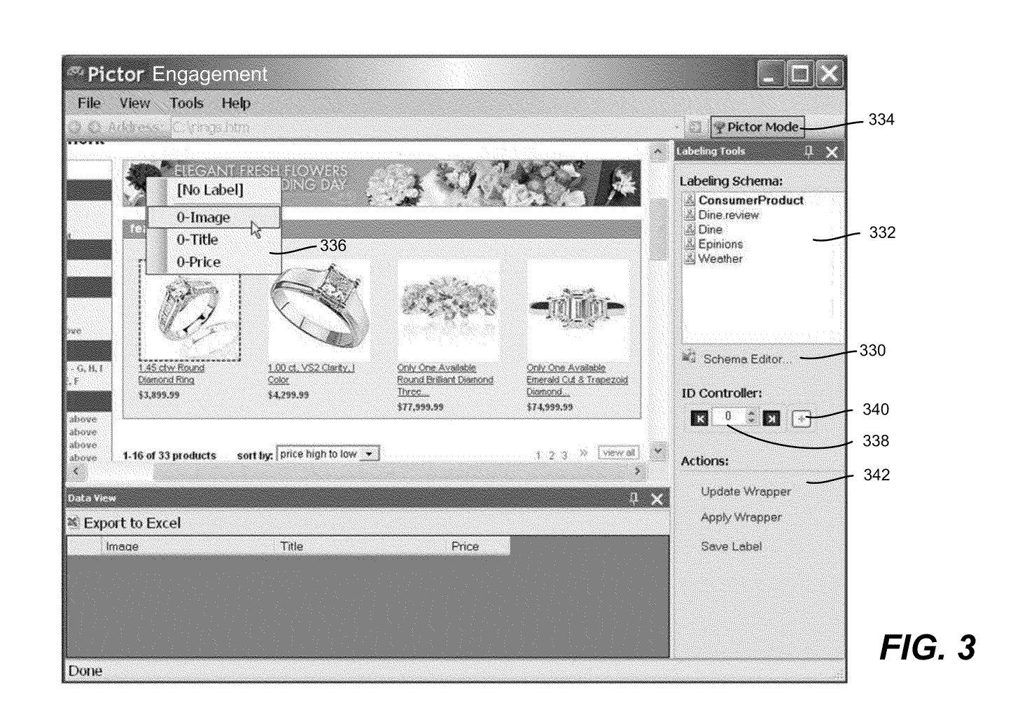

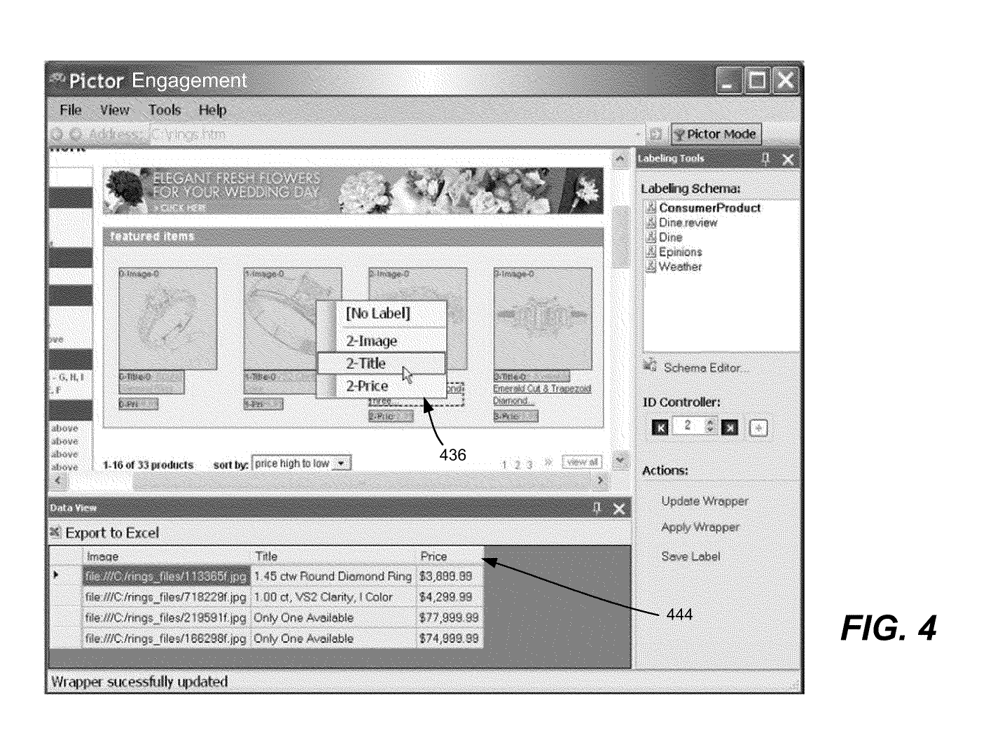

To help describe the operation of the tool 102, FIGS. 3 and 4 show an example of the user interface when presenting a shopping website. In this example, the extraction schema is designed such that each record contains three fields (or attributes), namely Image, Title, and Price; (a schema specifies the structure of extracted data and provides candidate labels for the purpose of labeling). Note that the tool 102 may use existing schemas, and/or provide a schema editor that enables creation and modification of a schema, by which users can specify what kind of attributes an extracted record is to contain. In the example of FIG. 3, such a schema editor may be invoked via button 330. Further, there is a schema selection panel 332 by which users may select a saved schema before performing the labeling in a labeling mode.

As described above, given a new page, the labeling process may use existing wrappers by detecting applicable wrappers. More particularly, as represented by step 204 of FIG. 2, if one or more wrappers generated from other similar pages exist, they may be applied to records of the current page (step 210) in order to predict other labels for records that follow similar patterns/structure. Note that the detection of existing applicable wrappers may be automatically performed by the tool 102 when it enters the labeling mode.

In the event that no applicable wrappers exist for a given record, the user needs to assign labels (as detected by step 206) to each unlabeled record. In the labeling mode of the tool, assigning labels to a record can be accomplished with relatively few mouse clicks, as illustrated in FIG. 3.

As shown in FIG. 3, the tool's user interface 110 includes an embedded web browser which can be used in a browsing mode and a labeling mode. In the browsing mode, online or offline webpages can be opened for labeling. When an opened page is completely loaded, the user can switch to the labeling mode by clicking a switch button 334 or taking some other appropriate action. As also shown in FIG. 3, when in the labeling mode, the webpage being labeled is displayed in a main panel; while moving the mouse cursor on the webpage, a visible indication may be used to follow the cursor to indicate which webpage element is being selected. In this example, selection of (e.g., via right-clicking) a selected element pop-ups a context menu 336 providing the labeling options for the record corresponding to the element.

Also shown in the menu 336 is an identifier (ID “0”) before each attribute name for the selected record, which is used to align labeled attributes with a record ID. The ID distinguishes each record from the others. An ID controller mechanism 338 (e.g., text box and up and down arrows) allows selection of a record ID to label. When finished labeling a record, the user can click on the Plus (“+”) button 340 at the right of ID controller. In this example, when clicked, the system advances to label the next record, e.g., the ID prefix will change from 0 to 1 in the menu 336 and in the mechanism 338. In addition, for already labeled (e.g., automatically labeled) records, to correct a record such as a record having ID 6, the user may input a 6 (e.g., by typing or using the up and down buttons) in the text box of the ID controller mechanism 338, which will also change the ID prefix shown in the menu 336.

After a single record is labeled, it can be used to generate or update the underlying wrappers. This process is automatically done by the tool 102 when a user clicks “Update Wrappers” 342. This is represented in FIG. 2 via step 208. Note, however, that the tool can do such an update without waiting for the user to manually command the update operation. Thus, step 208 may represent detection of the command, or an automatic or semi-automatic (e.g., timed or number of new labels-dependent) operation.

As described above, the wrapper-assisted labeling strategy uses any previously generated wrappers to predict labels of similar records within a webpage, as represented by step 210. Referring to the examples of FIGS. 3 and 4, a wrapper generated from the label assigned to the first record may be used to predict labels for the other three similar records.

In many cases, records in the same page are very similar, even to the point of being identical in terms of internal DOM tree structure. Therefore, labeling as little as one record can generate a wrapper, which can in turn automatically label the remaining similar records without further manual labor. In general, only relatively few records need to be labeled to generate the wrappers needed to complete the labeling of the other records of a webpage.

However, particularly in the early stages of labeling, the existing wrappers may not be able to correctly predict all labels. For some records, they may have wrongly assigned labels, or some of the attributes of a record may not be labeled, that is, the record is not completely labeled. For example, in FIG. 4, the third record has at least one unlabeled attribute as indicated by the context menu 436. Note that other records have appropriately labeled attributes, as indicated by the export table 444 (which is empty in FIG. 3 before labeling).

Steps 212 and 214 allow the modification of wrong or incomplete labels assigned by the underlying wrappers. In general, the process of modifying labels of a record is very similar to that of assigning new labels. Step 216 allows any remaining unlabeled records to be labeled (by returning to step 206)

Step 218 represents determining whether the pages of the set have been labeled. If not, the process returns to step 202 to label the next page.

When the pages have been labeled, any new wrappers that have been generated are ready to be used in conjunction with previously existing wrappers, e.g., to label another set of webpages. The label records may be used as desired, e.g., exported to a program or other entity (such as a storage medium).

As can be seen, the labeling task for one page can be accomplished by labeling a new record, updating one or more wrappers, applying the wrappers to other records if possible, revising labels as needed, and repeating until complete. Any generated wrappers may then be used in labeling the next page and so on. Once labeling is complete, these and/or other pages may have their data extracted via the wrappers.

### Exemplary Operating Environment

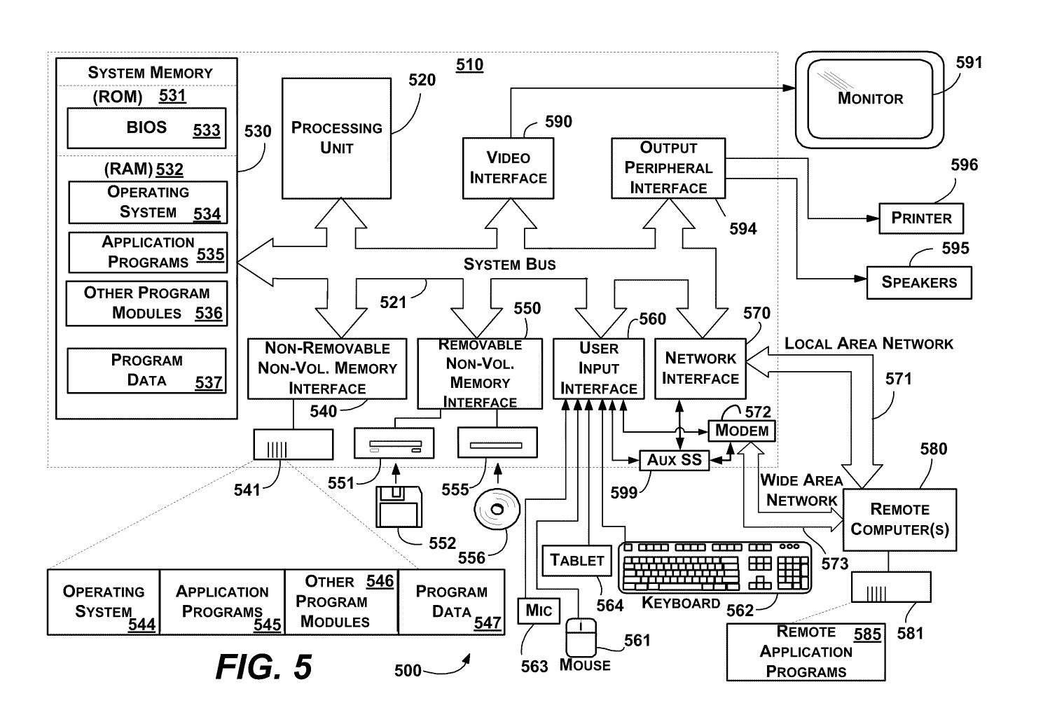

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, generating a wrapper for a record of a webpage based on a label assigned to that record, and adding the wrapper to a set of one or more existing wrappers.

2. The method of claim 1 further comprising, using the wrapper to label another record of the webpage.

3. The method of claim 2 wherein using the wrapper to label another record of the webpage comprises matching a sub-DOM tree corresponding to the other record of the webpage.

4. The method of claim 2 further comprising, selecting a closer matching wrapper to extract data from a record when two or more existing wrappers match the other record.

5. The method of claim 1 further comprising, using the wrapper to label another record of a different webpage.

6. The method of claim 1 further comprising, using a different wrapper in the set of one or more existing wrappers to label at least one other record of the webpage.

7. The method of claim 1 further comprising, revising an incomplete record based upon detection of interaction with a representation of a webpage element corresponding to the incomplete record.

8. The method of claim 1 further comprising, revising an incorrect record based upon detection of interaction with a representation of a webpage element corresponding to the incorrect record.

9. In a computing environment, a system comprising, a record-level wrapper tool, including logic that uses existing wrappers to automatically assign a label to a record of a webpage when an existing wrapper corresponds to that record, and a user interface for interaction with a display of a webpage to label a record of the webpage, the logic configured to update the existing wrappers with a new wrapper that is generated based upon the user interaction to label the record.

10. The system of claim 9 wherein the logic automatically assigns a label to another record of the webpage based upon the new wrapper.

11. The system of claim 9 wherein the logic automatically assigns the label to the record by matching a sub-DOM tree corresponding to that record.

12. The system of claim 9 wherein the user interface provides a menu for labeling a record based upon detection of interaction with a displayed element of the webpage that corresponds to the record.

13. The system of claim 9 wherein the user interface provides a mechanism to command an update the existing wrappers, the logic responding to the command by updating the existing wrappers with the new wrapper that is generated based upon the user interaction to label the one or more records, and with any other new wrapper that is generated based upon other user interaction to label another record.

14. The system of claim 9 wherein the user interface includes a mechanism for selecting an extraction schema.

15. The system of claim 9 wherein the user interface includes a mechanism for invoking an extraction schema editor.

16. The system of claim 9 wherein the user interface displays a set of labeled records to export.

17. One or more computer-readable media having computer-executable instructions, which when executed perform steps, comprising:
(a) for each record of a webpage, determining whether any existing wrapper applies to that record, and if so, using an applicable wrapper to label that record;
(b) detecting interaction with an element of the webpage to label a record corresponding to that element;
(c) generating a new wrapper based upon the interaction to label the record;
(d) applying the new wrapper to any unlabeled record of the webpage; and
(e) determining whether the webpage contains any unlabeled record, and if so, returning to step (b).

18. The one or more computer-readable media of claim 17 having further computer-executable instructions, comprising, detecting interaction with an element of the webpage to revise a label corresponding to that element.

19. The one or more computer-readable media of claim 17 having further computer-executable instructions, comprising, determining at step (e) that the webpage does not contain any unlabeled record, and in response, selecting a new webpage, and returning to step (a).

20. The one or more computer-readable media of claim 17 having further computer-executable instructions, comprising, exporting the labeled records to another entity.
